(19) United States
(12) Patent Application Publication
(10) Pub. No.: US 2026/0300386 A1
(43) Pub. Date: Oct. 1, 2026

(54) AUDIO QUESTION ANSWERING WITH GROUNDING

(71) Applicant: QUALCOMM Incorporated, San Diego, CA (US)

(72) Inventors: Yinyi GUO, San Diego, CA (US); Arvind Krishna SRIDHAR, San Diego, CA (US); Rehana MAHFUZ, Sunnyvale, CA (US); Erik VISSER, San Diego, CA (US)

(21) Appl. No.: 19/091,750

(22) Filed: Mar. 26, 2025

(51) Int. Cl. G06F 16/632; G06F 16/68; G06F 16/683

(52) U.S. Cl. CPC G06F 16/634; G06F 16/683; G06F 16/686

(57) ABSTRACT

Systems and techniques are described herein for processing audio data. For instance, a method for processing audio data is provided. The method may include encoding audio data to generate first audio embeddings; adapting the first audio embeddings to generate second audio embeddings; combining the first audio embeddings and the second audio embeddings to generate third audio embeddings; projecting the third audio embeddings to generate text projections; generating audio metadata based on the second audio embeddings; and processing the text projections, the audio metadata, and a query using a machine-learning model to generate a response to the query.

### TECHNICAL FIELD

The present disclosure generally relates to audio question answering. For example, aspects of the present disclosure include systems and techniques for processing audio data to generate answers to questions related to the audio data.

### BACKGROUND

A large language model (LLM) may be used to generate responses to questions. In some contexts, an audio question-answer system (AQA) system may use an LLM to generate answers to questions about audio data.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Systems and techniques are described for processing audio data. According to at least one example, a method is provided for processing audio data. The method includes: encoding audio data to generate first audio embeddings; adapting the first audio embeddings to generate second audio embeddings; combining the first audio embeddings and the second audio embeddings to generate third audio embeddings; projecting the third audio embeddings to generate text projections; generating audio metadata based on the second audio embeddings; and processing the text projections, the audio metadata, and a query using a machine-learning model to generate a response to the query.

In another example, an apparatus for processing audio data is provided that includes at least one memory and at least one processor (e.g., configured in circuitry) coupled to the at least one memory. The at least one processor configured to: encode the audio data to generate first audio embeddings; adapt the first audio embeddings to generate second audio embeddings; combine the first audio embeddings and the second audio embeddings to generate third audio embeddings; project the third audio embeddings to generate text projections; generate audio metadata based on the second audio embeddings; and process the text projections, the audio metadata, and a query using a machine-learning model to generate a response to the query.

In another example, a non-transitory computer-readable medium is provided that has stored thereon instructions that, when executed by one or more processors, cause the one or more processors to: encode the audio data to generate first audio embeddings; adapt the first audio embeddings to generate second audio embeddings; combine the first audio embeddings and the second audio embeddings to generate third audio embeddings; project the third audio embeddings to generate text projections; generate audio metadata based on the second audio embeddings; and process the text projections, the audio metadata, and a query using a machine-learning model to generate a response to the query.

In another example, an apparatus for processing audio data is provided. The apparatus includes: means for encoding audio data to generate first audio embeddings; means for adapting the first audio embeddings to generate second audio embeddings; means for combining the first audio embeddings and the second audio embeddings to generate third audio embeddings; means for projecting the third audio embeddings to generate text projections; means for generating audio metadata based on the second audio embeddings; and means for processing the text projections, the audio metadata, and a query using a machine-learning model to generate a response to the query.

In some aspects, one or more of the apparatuses described herein is, can be part of, or can include an extended reality device (e.g., a virtual reality (VR) device, an augmented reality (AR) device, or a mixed reality (MR) device), a vehicle (or a computing device, system, or component of a vehicle), a mobile device (e.g., a mobile telephone or so-called “smart phone”, a tablet computer, or other type of mobile device), a smart or connected device (e.g., an Internet-of-Things (IoT) device), a wearable device, a personal computer, a laptop computer, a video server, a television (e.g., a network-connected television), a robotics device or system, or other device. In some aspects, each apparatus can include an image sensor (e.g., a camera) or multiple image sensors (e.g., multiple cameras) for capturing one or more images. In some aspects, each apparatus can include one or more displays for displaying one or more images, notifications, and/or other displayable data. In some aspects, each apparatus can include one or more speakers, one or more light-emitting devices, and/or one or more microphones. In some aspects, each apparatus can include one or more sensors. In some cases, the one or more sensors can be used for determining a location of the apparatuses, a state of the apparatuses (e.g., a tracking state, an operating state, a temperature, a humidity level, and/or other state), and/or for other purposes.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 is a block diagram illustrating an example system through which a user may interact with a system regarding audio data, according to various aspects of the present disclosure;

FIG. 2 includes a diagram illustrating an example interaction between a user and an audio-interaction system;

FIG. 3 includes a diagram illustrating an example interaction between a user and an audio-interaction system, according to various aspects of the present disclosure;

FIG. 4 is a block diagram illustrating an example system for generating outputs in response to user inputs based on audio data;

FIG. 5 includes an example graph illustrating an example of classifications, according to various aspects of the present disclosure;

FIG. 6 is a block diagram illustrating an example system for generating outputs in response to user inputs based on text projections, according to various aspects of the present disclosure;

FIG. 7 is a block diagram illustrating an example system for training one or more machine-learning models for a system for generating outputs in response to user inputs, according to various aspects of the present disclosure;

FIG. 8 is a block diagram illustrating an example system for training one or more machine-learning models for a system for generating outputs in response to user inputs, according to various aspects of the present disclosure;

FIG. 9 illustrates a connection between an encoder and a cross attender, according to various aspects of the present disclosure;

FIG. 10 is a flow diagram illustrating an example process for processing audio data to generate answers to questions related to the audio data, in accordance with aspects of the present disclosure;

FIG. 11 is a block diagram illustrating an example of a deep learning neural network that can be used to perform various tasks, according to some aspects of the disclosed technology;

FIG. 12 is a block diagram illustrating an example of a convolutional neural network (CNN), according to various aspects of the present disclosure;

FIG. 13 is a block diagram illustrating a multimodal generative ML system for generating natural language responses based on natural language input from a prompt and any additional information;

FIG. 14 includes an example machine-learning model 1400 that may be used in various aspects of the present disclosure;

FIG. 15 is a block diagram of an example transformer in accordance with some aspects of the disclosure; and

FIG. 16 is a block diagram illustrating an example computing-device architecture of an example computing device which can implement the various techniques described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the exemplary aspects will provide those skilled in the art with an enabling description for implementing an exemplary aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage, or mode of operation.

An audio question-answer (QA) system may allow a user to interact with a machine-learning model that seeks to provide answers to questions about audio data. For example, a user may provide an Audio QA system with an audio file and ask one or more questions about the contents of the audio file, such as “what is in this audio file?” “does this audio file include music?” and/or “does this audio file include talking?”

Audio QA systems may use Large Audio-Language Models (LALM). Additionally Audio QA systems may leverage independent off-the-shelf audio models to extract high-level audio-semantic information (e.g., audio event tags, audio captions, etc.).

However, discrepancies across the audio semantic inputs to the LALM may causes confusion and inconsistency during a multi-turn QA dialogue with a user. Additionally, the audio-semantic information is fixed during the multi-turn dialogue. Prediction errors in off-the-shelf audio models (like an audio captioning decoder (ACD)) may degrade Audio QA performance and user experience.

Systems, apparatuses, methods (also referred to as processes), and computer-readable media (collectively referred to herein as “systems and techniques”) are described herein for processing audio data to generate answers to questions related to the audio data. For example, the systems and techniques described herein may receive a question from a user about audio data and generate an answer to the question based on the audio data.

The systems and techniques may use a training/inference system framework with an aligned, unified audio encoder. The audio encoder may be used to encode audio data for two or more (e.g., all) of the modules generating audio-semantic information to be input to an LALM of the systems and techniques. With a single, unified encoder, and separate decoders for extracting different sets of audio-semantic information, the audio-semantic information may be aligned with the audio input so that the audio-semantic information may enable the LALM to perform consistently.

Additionally, the systems and techniques may dynamically update and/or augment extracted audio metadata over the course of multi-turn conversion about audio data. For example, the systems and techniques may use a user's queries (e.g., as processed by a phrase extractor) in text-to-audio grounding model to update and/or augment audio metadata.

The systems and techniques may use a contrastive learning audio pretrained (CLAP) audio and/or text encoder to updated and/or augment the audio metadata. For example, the systems and techniques may use the CLAP audio and/or text encoders as a text-to-audio grounding model.

Once a user asks a question about a particular sound, the systems and techniques may process the question using a phrase-extraction module to identify the phrase describing the sound. The systems and techniques may use the text-to-audio ground model to obtain audio-grounding information based on the identified phrase.

Various aspects of the application will be described with respect to the figures below.

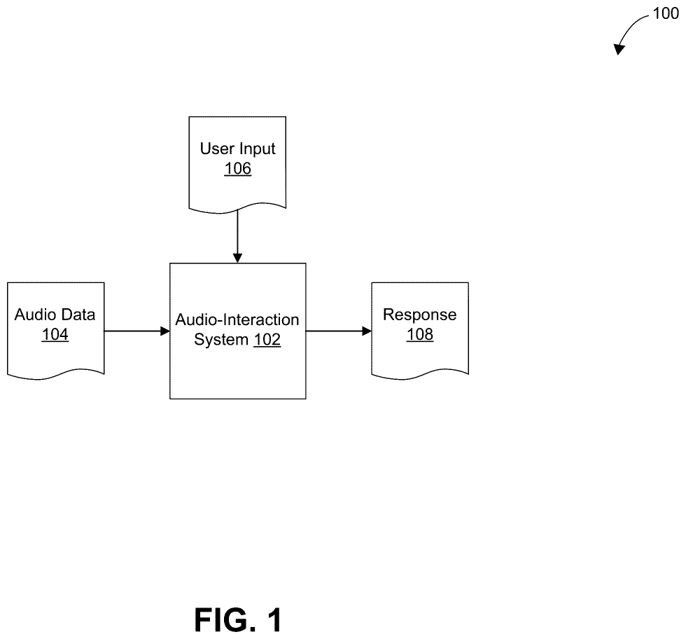

FIG. 1 is a block diagram illustrating an example system 100 through which a user may interact with a system regarding audio data 104, according to various aspects of the present disclosure. For example, audio-interaction system 102 may obtain audio data 104. A user may provide user input 106 to audio-interaction system 102 regarding audio data 104. Audio-interaction system 102 may generate response 108 responsive to user input 106, based on audio data 104.

Audio data 104 may include a number of audio events. For example, audio data 104 may include sound recordings of various events, such as a person speaking, a dog barking, a bell ringing, etc. Audio data 104 may be according to any suitable format, such as Motion-Picture Experts Group (MPEG) Audio Layer III (MP3), waveform audio file format (WAV), etc.

A user may provide user input 106 to audio-interaction system 102 through any suitable format, for example, the user may interact with audio-interaction system 102 via a text chat system or through an audio chat system. For example, the user may enter user input 106 as a text query into a text-based chat application. As another example, the user may speak user input 106 and a microphone may record user input 106 and convert the spoken user input 106 into a text format. User input 106 may relate to audio events of audio data 104. For example, user input 106 may include a user input regarding the audio events, such as “does audio data 104 include a dog barking?” or “at what time of audio data 104 does a bell ring?”

Audio-interaction system 102 may generate response 108 based on audio data 104 and responsive to user input 106. Response 108 may have any suitable format. In some aspects, response 108 may have the same format as user input 106. For example, response 108 may be a text response displayed at a display of a text-based chat application. As another example, response 108 may be a vocalized response output by a speaker.

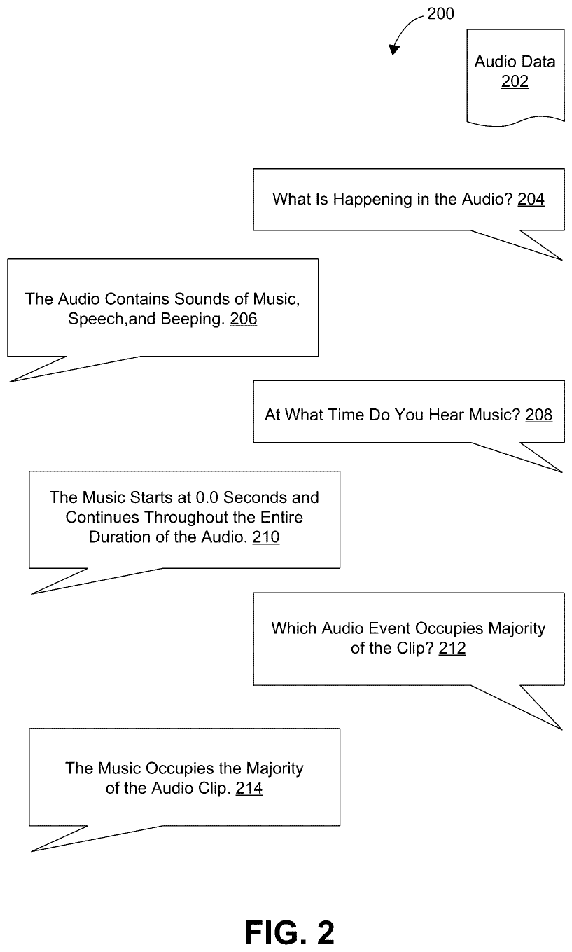

FIG. 2 includes a diagram illustrating an example interaction 200 between a user and an audio-interaction system (e.g., an audio QA system). For example, interaction 200 may be an example of a user providing multiple user inputs (e.g., questions) to the audio-interaction system and the audio-interaction system providing multiple responses.

Interaction 200 may begin with (or be preceded by) the audio-interaction system obtaining audio data 202. For example, the user may provide audio data 202 to the audio-interaction system.

User input 204 is an example of a first question. For example, user input 204 may be, or may include, “What is happening in the audio?”

Response 206 may be an example of a first response. Response 206 may include “The audio contains sounds of music, speech, and beeping.” To generate response 206, the audio-interaction system may provide user input 204, and audio data 202 to a LALM and the LALM may generate response 206 based on user input 204 and audio data 202.

User input 208 is an example of a second question, for example, following the first question. For example, user input 208 may be, or may include, “At what time do you hear music?”

Response 210 may be an example of a second response. Response 210 may include “The music starts at 0.0 seconds and continues throughout the entire duration of the audio.” To generate response 210, the audio-interaction system may provide user input 208, and audio data 202 to the LALM and the LALM may generate response 210 based on user input 208 and audio data 202.

User input 212 is an example of a third question, for example, following the second question. For example, user input 212 may be, or may include, “Which audio event occupies majority of the clip?”

Response 214 may be an example of a third response. Response 214 may include: “The music occupies the majority of the audio clip.” To generate response 214, the audio-interaction system may provide user input 212, and audio data 202 to the LALM and the LALM may generate response 214 based on user input 212 and audio data 202.

In interaction 200, the audio-interaction system misses wind noise which is a major audio event in audio data 202. The music event occurs twice-once at the start and again towards the end of audio data 202. The audio-interaction system responds as if the music plays throughout audio data 202. Response 214 is about music and misses the wind noise.

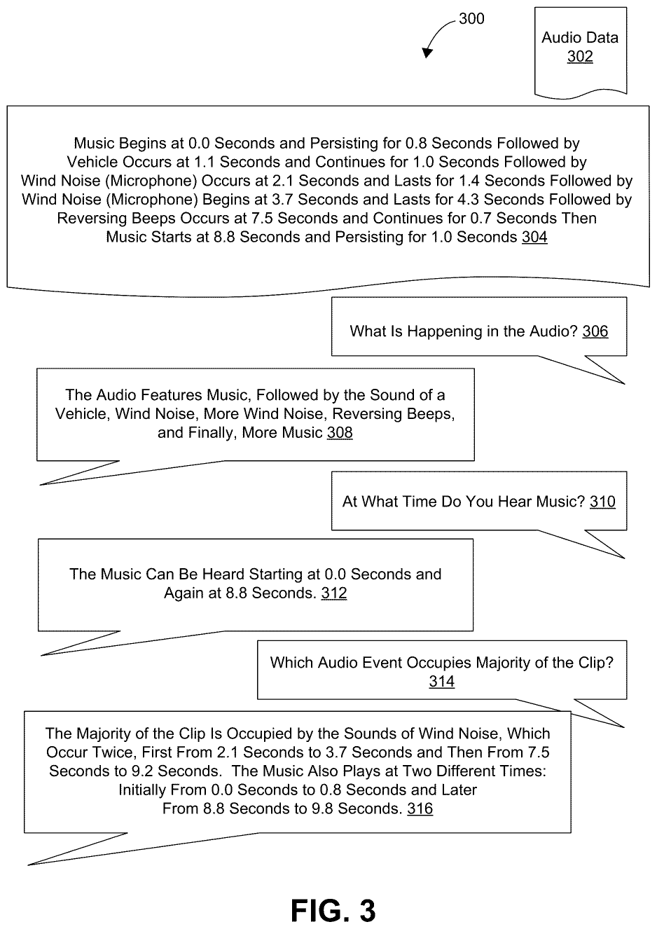

FIG. 3 includes a diagram illustrating an example interaction 300 between a user and an audio-interaction system (e.g., an audio QA system), according to various aspects of the present disclosure. For example, interaction 300 may be an example of a user providing multiple instances of user input 106 to an audio-interaction system 102 and audio-interaction system 102 providing multiple instances of response 108.

Interaction 300 may begin with (or be preceded by) the audio-interaction system obtaining audio data 302. For example, the user may provide audio data 302 to the audio-interaction system. Audio data 302 may be an example of audio data 104. Audio data 302 may be the same as, or may be substantially similar to, audio data 202.

The audio-interaction system may generate audio metadata 304 based on audio data 302. For example, the audio-interaction system may analyze audio metadata 304 using one or more modules for generating audio-semantic information to generate audio metadata 304, according to various aspects of the present disclosure.

User input 306 is an example of a first instance of user input 106, for example, a first question. For example, user input 306 may be, or may include, “What is happening in the audio?”

Response 308 may be an example of a first instance of response 108. Response 308 may be, or may include: “The audio features music, followed by the sound of a vehicle, wind noise, more wind noise, reversing beeps, and finally, more music.” To generate response 308, the audio-interaction system may provide user input 306, audio metadata 304, and audio data 302 to a LALM and the LALM may generate response 308 based on user input 306, audio metadata 304, and audio data 302.

User input 310 is an example of a second instance of user input 106, for example, following user input 306, for example, a second question. For example, user input 310 may be, or may include, “At what time do you hear music?”

Response 312 may be an example of a second instance of response 108. Response 312 may include: “The music can be heard starting at 0.0 seconds and again at 8.8 seconds.” To generate response 312, the audio-interaction system may provide user input 310, audio metadata 304, and audio data 302 to a LALM and the LALM may generate response 312 based on user input 310, audio metadata 304, and audio data 302.

User input 314 is an example of a third instance of user input 106, for example, following user input 310, for example, a third question. For example, user input 314 may be, or may include, “Which audio event occupies majority of the clip?”

Response 316 may be an example of a third instance of response 108. Response 316 may include: “The majority of the clip is occupied by the sounds of wind noise, which occur twice, first from 2.1 seconds to 3.7 seconds and then from 7.5 seconds to 9.2 seconds. The music also plays at two different times: initially from 0.0 seconds to 0.8 seconds and later from 8.8 seconds to 9.8 seconds.” To generate response 316, the audio-interaction system may provide user input 314, audio metadata 304, and audio data 302 to a LALM and the LALM may generate response 316 based on user input 314, audio metadata 304, and audio data 302.

In interaction 300, the audio-interaction system correctly detects all the audio events. The audio-interaction system may detect all the audio events based on the audio-interaction system providing audio metadata 304 to the LALM when providing queries to the LALM. Audio metadata 304 may aid the LALM in accurately responding to queries.

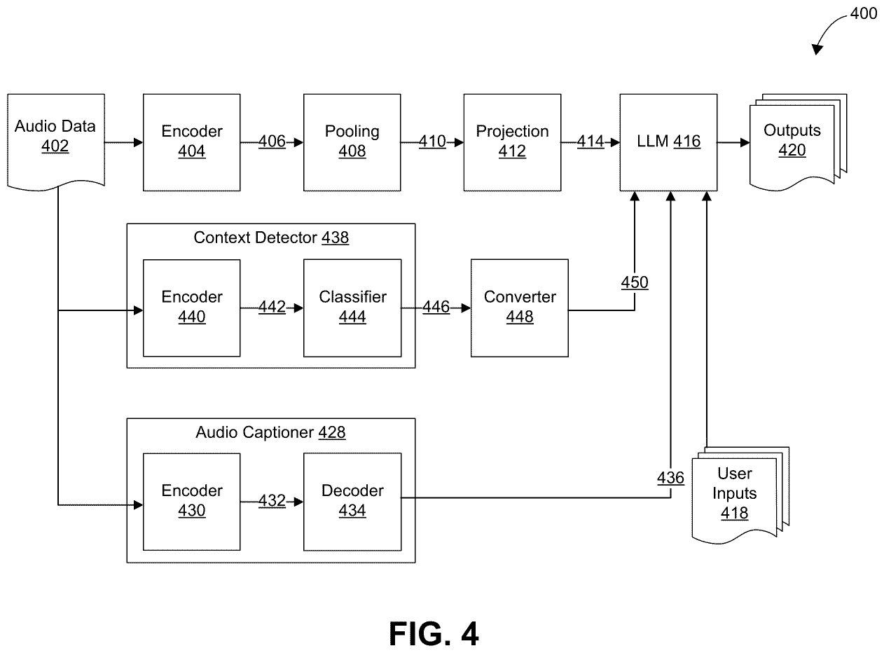

FIG. 4 is a block diagram illustrating an example system 400 for generating outputs 420 in response to user inputs 418 based on audio data 402. System 400 may be an example of audio-interaction system 102, for example, audio-interaction system 102 may implement system 400. As such, audio data 402 may be an example of audio data 104, user inputs 418 may be examples of multiple instances of user input 106, and outputs 420 may be examples of multiple instances of response 108.

Encoder 404 may encode audio data 402 to generate audio embeddings 406. Encoder 404 may be an audio encoder, for example, a machine-learning model trained to generate embeddings based on audio data. In the present disclosure, the term embeddings may refer to representations of data (e.g., text, images, or audio) as points in a continuous vector space, where the location of each point captures the underlying relationships and similarities between different data points.

Pooling 408 may reduce a dimensionality of audio embeddings 406 to generate audio embeddings 410. For example, pooling 408 may take an average of values along one dimension of audio embeddings 406 to generate audio embeddings 410 with one fewer dimensions.

Projection 412 may generate text projections 414 based on audio embeddings 410. For example, projection 412 may be an embedding (e.g., a representations of text as points in a continuous vector space).

Some audio-interaction systems may use a large language model (LLM) (e.g., LLM 416) to process text projections and user inputs to generate outputs. Additionally, system 400 includes audio captioner 428 and context detector 438. In addition to processing text projections 414 using LLM 416, system 400 may process outputs of audio captioner 428 and outputs of context detector 438 using LLM 416 to generate outputs 420.

Audio captioner 428 may be, or may include, a machine-learning model trained to generate text based on audio data (e.g., an audio-captioning machine-learning model). Audio captioner 428 may include an encoder 430 and a decoder 434. Encoder 430 may encode audio data 402 to generate audio embedding 432 and decoder 434 may decode audio embedding 432 to generate audio captions 436. Audio captions 436 may be, or may include, text that describes audio data 402.

Context detector 438 may be, or may include, a machine-learning model trained to generate text based on audio data. Context detector 438 may be trained to classify audio events in audio data and to output classifiers of the audio events along with timestamps associated with the audio events.

Context detector 438 may include an encoder 440 and a classifier 444. Encoder 440 may encode audio data 402 to generate audio embedding 442 and classifier 444 may decode audio embedding 442 to generate classifications 446.

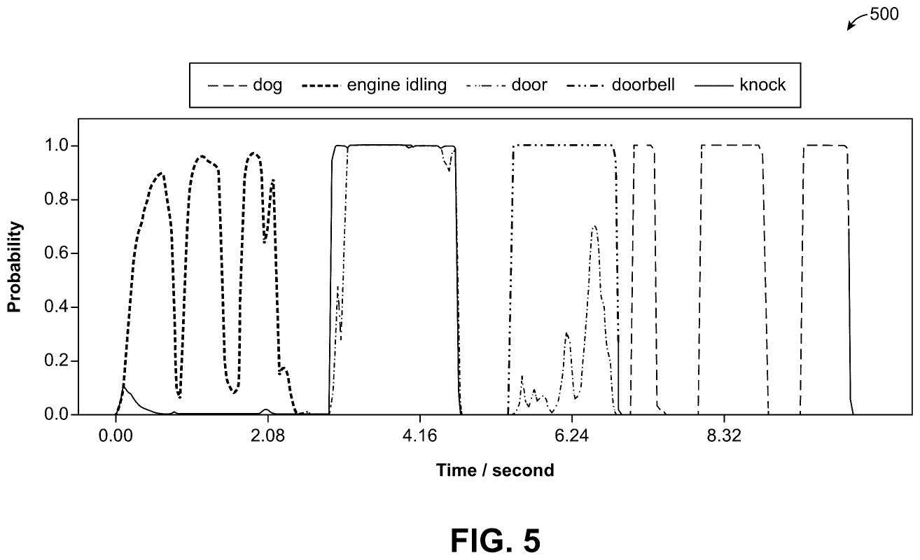

Classifications 446 may include indications of probabilities of various classes of audio events. For example, FIG. 5 includes an example graph 500 illustrating an example of classifications 446, according to various aspects of the present disclosure. The x-axis of graph 500 represents time and the y-axis of graph 500 represents probabilities. Graph 500 includes multiple lines. Each of the lines may correspond to a classification. At any given time, there may be a probability that an audio event of each class is occurring in audio data. Graph 500 may show the probabilities that audio events of the various classes are occurring in the audio data. For example, at around 4 seconds into the audio data, there is a high probability that an audio event related to a “door” is occurring. Similarly, at around 4 seconds into the audio data, there is a high probability that an audio event related to a “dog” is occurring.

Converter 448 may convert classifications 446 into a predetermined format (e.g., including descriptors of audio events and timestamps, for example, as comma-separated values) to generate audio metadata 450. Audio metadata 304 of FIG. 3 may be an example of audio metadata 450.

LLM 416 may process text projections 414, audio captions 436, audio metadata 450, and user inputs 418 to generate outputs 420. As described with regard to FIG. 3, system 400 using audio metadata 450 may improve outputs 420 by providing LLM 416 with context for responding to user inputs 418.

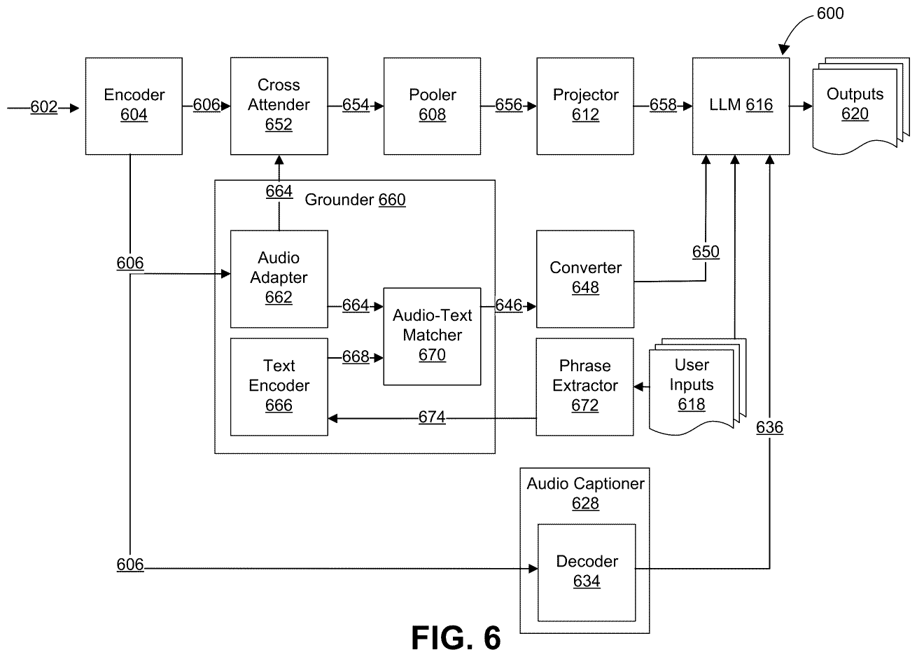

FIG. 6 is a block diagram illustrating an example system 600 for generating outputs 620 in response to user inputs 618 based on text projections 658, according to various aspects of the present disclosure. System 600 may be an example of audio-interaction system 102, for example, audio-interaction system 102 may implement system 600. As such, audio data 602 may be an example of audio data 104, user inputs 618 may be examples of multiple instances of user input 106, and outputs 620 may be examples of multiple instances of response 108.

Encoder 604 may encode audio data 602 to generate audio embeddings 606. Encoder 604 may be an audio encoder, for example, a machine-learning model trained to generate embeddings based on audio data. Encoder 604 may be similar to encoder 404 of system 400.

Cross attender 652 may combine audio embeddings 606 and audio embeddings 664 to generate audio embeddings 654. Cross attender 652 may be, or may include, a transformer machine-learning model (e.g., a cross-attention transformer). Cross attender 652 may perform a cross-attention operation to determine audio embeddings 654.

Pooler 608 may reduce a dimensionality of audio embeddings 654 generate audio embeddings 656. Projector 612 may generate text projections 658 based on audio embeddings 656. For example, text projections 658 may be an embedding (e.g., a representations of text as points in a continuous vector space).

System 600 may use a large language model (LLM) 616 to process text projections 658 and user inputs 618 to generate outputs 620. Additionally, system 600 includes audio captioner 628 and grounder 660. In addition to processing text projections 658 using LLM 616, system 600 may process audio captions 636 and audio metadata 650 using LLM 616 to generate outputs 620.

Audio captioner 628 may be, or may include, a machine-learning model trained to generate text based on audio data (e.g., an audio-captioning machine-learning model). Audio captioner 628 may include a decoder 634. Audio captioner 628 may receive audio embeddings 606 (e.g., encoded by encoder 604) and decoder 634 may decode audio embeddings 606 to generate audio captions 636. Audio captions 636 may be, or may include, text that describes audio data 602.

Audio captioner 628 of system 600 may be similar to audio captioner 428 of system 400. However, whereas audio captioner 428 includes encoder 430 to encode audio data 402, audio captioner 628 does not. Rather audio captioner 628 uses audio embeddings 606 encoded by encoder 604. By system 600, using audio embeddings 606 from encoder 604 for both projector 612 and LLM 616 and audio captioner 628, system 600 may improve the consistency of text projections 658 and audio captions 636. LLM 616 may be able to generate better outputs 620 than other systems that include separate encoders for their respective LLMs, and audio captioners.

Grounder 660 may generate classifications 646 based on audio embeddings 606. grounder 660 may be, or may include, one or more machine-learning models trained to generate output classifications on input audio embeddings. Grounder 660 may perform similar operations in system 600 to the operations performed by context detector 438 in system 400. However, whereas context detector 438 included an encoder 440, grounder 660 may use audio embeddings 606 encoded by encoder 604. By system 600, using audio embeddings 606 from encoder 604 for both projector 612 and grounder 660, system 600 may improve the consistency of text projections 658 and audio metadata 650. LLM 616 may be able to generate better outputs 620 than other systems that include separate encoders for their respective LLMs and context detectors.

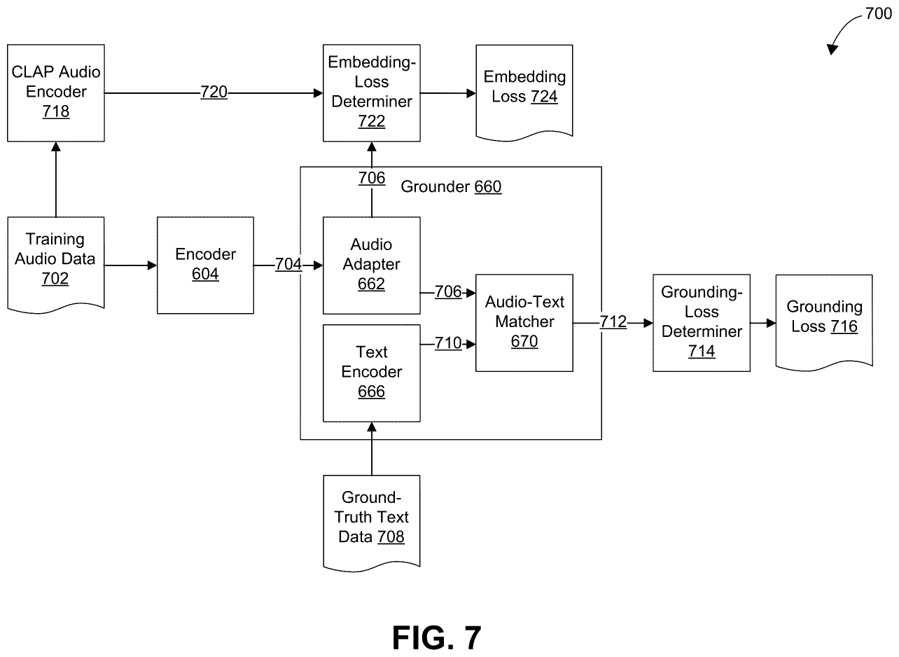

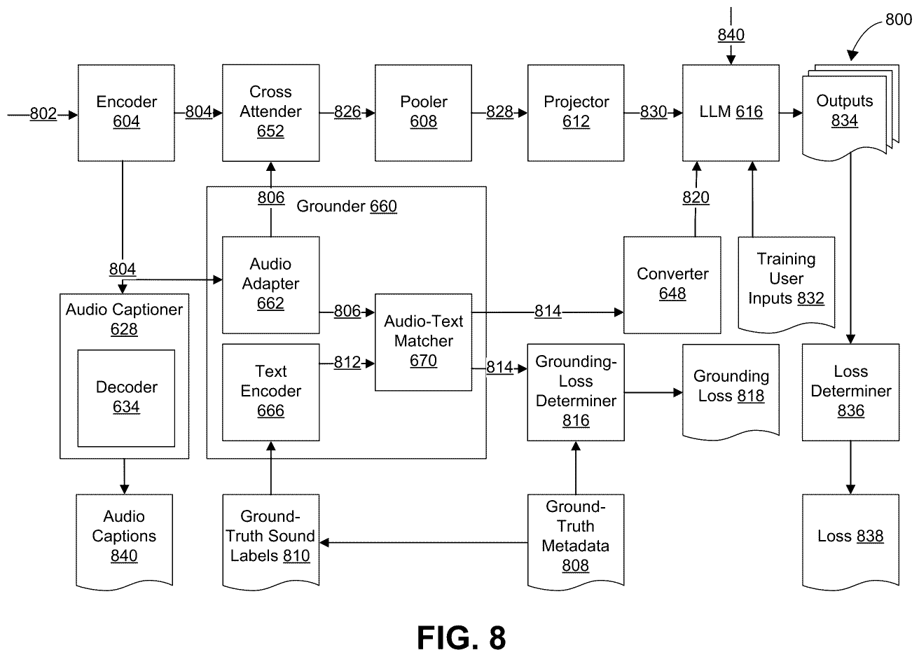

Additionally, whereas context detector 438 includes a classifier 444, trained to classify audio data according to trained classes, grounder 660 includes an audio adapter 662. Audio adapter 662 may be trained to generate output audio embeddings based on input audio embeddings. For example, audio adapter 662 may generate audio embeddings 664 based on audio embeddings 606. Audio adapter 662 may be trained such that the output audio embeddings are similar to text embeddings produced by text encoder 666 when text encoder 666 processes text that is related to input audio data on which the input audio embeddings are based. For example, audio adapter 662 and text encoder 666 may be trained according to a contrastive-learning approach. For instance, audio adapter 662 and text encoder 666 may be trained together such that when training audio data is provided to an encoder and audio adapter 662 and a training text (that is associated with the training audio data) is provided to text encoder 666, audio adapter 662 produces audio embeddings that are similar to (e.g., have a similar L2 distance to) text embeddings produced by text encoder 666. Additional detail regarding the training of audio adapter 662 and text encoder 666 is provided with regard to FIG. 7 and FIG. 8.

Grounder 660 may ground system 600. For example, in addition to providing user inputs 618 to LLM 616 (e.g., to generate outputs 620 in response to user inputs 618), system 600 may provide user inputs 618 to phrase extractor 672 which may provide phrases 674 to grounder 660. Phrase extractor 672 may extract phrases 674 from user inputs 618. For example, when user inputs 618 relates to a particular sound, phrase extractor 672 may identify the words of user inputs 618 that describe the particular sound. Phrase extractor 672 may be, or may include, an algorithm-based text analyzer and extractor. For example, phrase extractor may use a list of words to identify phrases to extract. Additionally or alternatively, phrase extractor 672 may be, or may include, a machine-learning model trained to extract phrases related to audio events from user inputs.

Grounder 660 may use phrases 674 from prior instances of user inputs 618 to ground system 600. For example, text encoder 666 may generate text embeddings 668 based on phrases 674. Text encoder 666 may be trained with audio adapter 662 to such that when text encoder 666 is provided with text, text encoder 666 will generate text embeddings that are similar to (e.g., have a relatively small L2 distance to) audio embeddings based on audio data that is related to the text.

Audio-text matcher 670 may generate classifications 646 based on audio embeddings 664 and text embeddings 668. Classifications 646 may be the same as, or may be substantially similar to, classifications 446.

Converter 648 may generate audio metadata 650 based on classifications 646. Converter 648 may be the same as, may be substantially similar to, and/or may perform the same, or substantially the same, operations as converter 448. Audio metadata 650 may be based, at least in part, on prior instances of user inputs 618. Thus, system 600 may use audio metadata 650 to store, implicitly, information based on prior instances of user inputs 618. Thus, grounder 660 may ground system 600 by causing system 600 to operate using example data.

LLM 616 may process text projections 658, audio captions 636, audio metadata 650, and user inputs 618 to generate outputs 620. As described with regard to FIG. 3, system 600 using audio metadata 650 may improve outputs 620 by providing LLM 616 with context for responding to user inputs 618.

System 600 may be, or may include, a framework for integrating audio semantic knowledge into a large language model (LLM)-based audio question answering (AQA) system. System 600 may implement a unified audio encoder (e.g., encoder 604). Encoder 604 may be a single, unified encoder used for projector 612, audio captioner 628 and grounder 660. Using encoder 604 may cause audio-semantic information to be consistently aligned with audio data 602. For example, text projections 658, audio metadata 650, and audio captions 636 may be aligned. System 600 may include separate decoders (e.g., in audio captioner 628, projector 612, and in grounder 660). Different decoders may be used to extract various types of audio information, leading to consistent and QA performance. System 600 causes that audio-semantic information to be aligned with the audio input, providing a more accurate and consistent response to user queries.

System 600 may dynamically update audio metadata 650. For example, system 600 may dynamically update and/or augment extracted audio metadata 650 during multi-turn conversations. For instance, phrase extractor 672 may extract phrases 674 from user inputs 618 and grounder 660 may incorporate data from phrases 674 into audio metadata 650.

Grounder 660 includes audio adapter 662 which may be based on a CLAP audio/text encoder. Grounder 660 may ground text to audio. For example, grounder 660 may use phrases 674 to obtain new audio grounding information.

Additionally, grounder 660 grounding system 600 based on user inputs 618 may improve the performance of system 600 as compared with system 400. Further, audio adapter 662 and text encoder 666 may represent improvements of system 600 over system 400. For example, audio adapter 662 and text encoder 666 may generate better embeddings than embeddings generated by context detector 438.

One or more elements of system 600 (e.g., encoder 604, cross attender 652, projector 612, LLM 616, decoder 634, converter 648, audio adapter 662, text encoder 666, audio-text matcher 670, and/or phrase extractor 672) may be trained using a multi-turn cross-entropy loss. For example, several instances of user inputs 618 may be provided as inputs to system 600. Several corresponding ground truth outputs may may be used to determine cross-entropy losses. Further, parameters (e.g., weights of one or more elements of system 600 (e.g., encoder 604, cross attender 652, projector 612, LLM 616, decoder 634, converter 648, audio adapter 662, text encoder 666, audio-text matcher 670, and/or phrase extractor 672) may be adjusted based on the cross-entropy losses. The parameters may be adjusted such that in further iterations of the training process, system 600 may generate outputs that are more similar to the ground-truth outputs. Additional detail regarding the training of elements of system 600 is provided with regard to FIG. 7 and FIG. 8.

FIG. 7 is a block diagram illustrating an example system 700 for training one or more machine-learning models for a system for generating outputs in response to user inputs, according to various aspects of the present disclosure. For example, system 700 may be used to train audio adapter 662 and/or text encoder 666. System 700 may train audio adapter 662 and text encoder 666 through an iterative backpropagation process. Additionally, in some aspects, system 700 may be used to train encoder 604 and/or audio-text matcher 670.

System 700 may train audio adapter 662 (and in some cases encoder 604) and text encoder 666 according to a contrastive-learning training approach. For example, system 700 may train audio adapter 662 (and in some cases encoder 604) and text encoder 666 as if audio adapter 662 (and in some cases encoder 604) and text encoder 666 were a contrastive-learning audio encoder and a contrastive-learning text encoder (e.g., of a contrastive learning audio pretrained (CLAP) network).

For example, system 700 may provide training audio data 702 to encoder 604. Training audio data 702 may be, or may include, audio data of a corpus of training data. Ground-truth text data 708 may relate to training audio data 702. For example, ground-truth text data 708 may include text data that corresponds to training audio data 702 (e.g., a textual description of training audio data 702 and/or a textual description of audio events of training audio data 702).

Encoder 604 may process training audio data 702 to generate audio embeddings 704. In some aspects, encoder 604 may be frozen in system 700. In other aspects, system 700 may adjust parameters (e.g., weights) of encoder 604 based on losses determined by system 700 (e.g., grounding loss 716 and/or embedding loss 724).

Audio adapter 662 may process audio embeddings 704 to generate audio embeddings 706. Audio adapter 662 may adjust values of audio embeddings 704. For example, audio adapter 662 may adjust values in the embedding space of audio embeddings 704 to be different, based on the training of audio adapter 662.

Text encoder 666 may process ground-truth text data 708 to generate text embeddings 710. Audio-text matcher 670 may generate classifications 712 based on audio embeddings 706 and text embeddings 710.

Grounding-loss determiner 714 may determine grounding loss 716 based on classifications 712. Grounding loss 716 may be based on a difference between audio embeddings 706 and text embeddings 710. System 700 may adjust parameters (e.g., weights) of audio adapter 662 to decrease grounding loss 716 in further iterations of the iterative training process.

For example, system 700 may adjust parameters (e.g., weights) of audio adapter 662 such that in further iterations of the iterative training process, audio adapter 662 may produce further instances of audio embeddings 706 that are more similar to text embeddings 710 produced by text encoder 666 (e.g., when audio adapter 662 processes audio embeddings 704 based on training audio data 702 and text encoder 666 processes ground-truth text data 708 that corresponds to training audio data 702). Additionally, system 700 may adjust parameters (e.g., weights) of text encoder 666 such that in further iterations of the iterative training process, text encoder 666 may produce further instances of text embeddings 710 that are more similar to audio embeddings 706 produced by audio adapter 662 (e.g., when text encoder 666 processes ground-truth text data 708 and audio adapter 662 processes audio embeddings 704 based on training audio data 702 and that corresponds to ground-truth text data 708).

In some aspects, system 700 may adjust parameters of encoder 604 and/or audio-text matcher 670 based on grounding loss 716. In other aspects, encoder 604 and/or audio-text matcher 670 may be frozen in system 700.

Additionally or alternatively, system 700 may train audio adapter 662 according to a knowledge-distillation process. For example, system 700 may include CLAP audio encoder 718. CLAP audio encoder 718 may be trained with text encoder 666 such that CLAP audio encoder 718 and text encoder 666 produce similar embeddings when provided with corresponding inputs. For example, CLAP audio encoder 718 may be trained to produce an audio embedding that is similar to a text embedding produced by text encoder 666 when CLAP audio encoder 718 is provided with training audio data and text encoder 666 is provided with corresponding text data.

CLAP audio encoder 718 may process training audio data 702 to generate audio embeddings 720. Embedding-loss determiner 722 may compare audio embeddings 706 (generated by audio adapter 662) with audio embeddings 720 (generated by CLAP audio encoder 718). Embedding-loss determiner 722 may determine embedding loss 724 based on differences between audio embeddings 706 and audio embeddings 720. System 700 may adjust parameters (e.g., weights) of audio adapter 662 based on embedding loss 724 to decrease embedding loss 724 in further iterations of the iterative training process.

FIG. 8 is a block diagram illustrating an example system 800 for training one or more machine-learning models for a system for generating outputs in response to user inputs, according to various aspects of the present disclosure. For example, system 800 may be used to train cross attender 652, projector 612, decoder 634, audio adapter 662, and/or text encoder 666. System 800 may train cross attender 652, projector 612, decoder 634, audio adapter 662, and text encoder 666 through an iterative backpropagation process. In some aspects, one or more of cross attender 652, projector 612, decoder 634, audio adapter 662, and/or text encoder 666 may be frozen while others of cross attender 652, projector 612, decoder 634, audio adapter 662, and/or text encoder 666 are trained.

System 800 may provide training audio data 802 to encoder 604. Training audio data 802 may be, or may include, audio data of a corpus of training data. Training audio data 802 may relate to ground-truth metadata 808. For example, ground-truth metadata 808 may include metadata that corresponds to training audio data 802. For instances ground-truth metadata 808 may include descriptors of audio events and time stamps related to the audio events. Ground-truth sound labels 810 may be, or may include, a subset of ground-truth metadata 808. For example, ground-truth sound labels 810 may include descriptors of audio events (e.g., without timestamps).

Encoder 604 may process training audio data 802 to generate audio embeddings 804. Audio adapter 662 may process audio embeddings 804 to generate audio embeddings 806. Text encoder 666 may process ground-truth sound labels 810 to generate text embeddings 812. Audio-text matcher 670 may process audio embeddings 806 and text embeddings 812 to generate classifications 814.

Grounding-loss determiner 816 may compare classifications 814 with ground-truth metadata 808 and determine grounding loss 818 based on the comparison. Grounding loss 818 may be based on a difference between classifications 814 and ground-truth metadata 808. Grounding-loss determiner 816 may determine grounding loss 818 as a cross-entropy loss.

System 800 may adjust parameters (e.g., weights) of text encoder 666 and/or audio adapter 662 to decrease grounding loss 818 in further instances of the training process. For example, system 800 may adjust parameters of text encoder 666 and/or audio adapter 662 such that in further iterations of the iterative training process, classifications 814 (generated based on audio embeddings 806 and text embeddings 812) is more similar to ground-truth metadata 808.

Additionally or alternatively, cross attender 652 may generate audio embeddings 826 based on audio embeddings 804 and audio embeddings 806. Pooler 608 may generate audio embeddings 828 based on audio embeddings 826. Projector 612 may generate text projections 830 based on audio embeddings 828. Decoder 634 may generate audio captions 840 based on audio embeddings 804. LLM 616 may generate outputs 834 based on text projections 830, audio captions 840, audio metadata 820, and training user inputs 832.

Loss determiner 836 may determine loss 838 based on outputs 834. For example, loss determiner 836 may determine loss 838 based on a multi-turn cross-entropy loss. System 800 may adjust parameters (e.g., weights) of cross attender 652, projector 612, decoder 634, text encoder 666, and/or audio adapter 662 to decrease loss 838 in further instances of the training process. For example, system 800 may adjust parameters of cross attender 652, projector 612, decoder 634, text encoder 666, and/or audio adapter 662 such that in further iterations of the iterative training process, loss 838 decreases with each subsequent iteration.

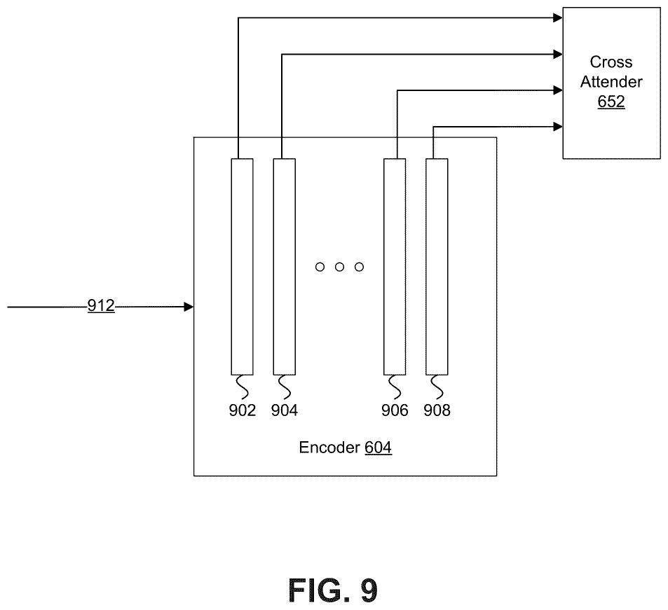

FIG. 9 illustrates a connection between encoder 604 and cross attender 652, according to various aspects of the present disclosure. FIG. 9 illustrates residual connections (or intermediate outputs) of encoder 604 (which may be, or may include, a transformer-based audio encoder) into cross attender 652. The intermediate activation layer of encoder 604 (e.g., including 902, 904, 906, and 908 as examples) may have a strong correspondence with audio data 602. Intermediate layers may include rich semantic information.

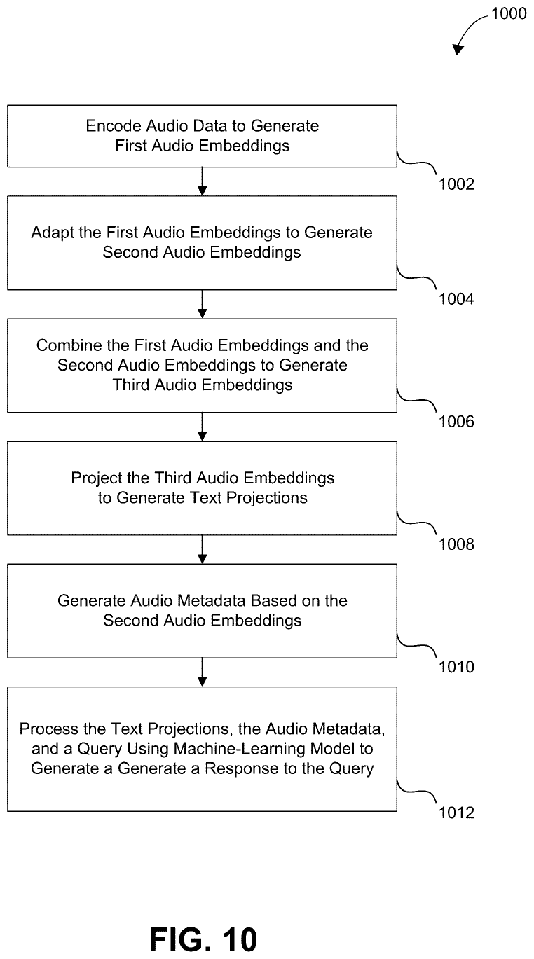

FIG. 10 is a flow diagram illustrating an example process 1000 for processing audio data to generate answers to questions related to the audio data, in accordance with aspects of the present disclosure. One or more operations of process 1000 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the one or more operations of process 1000. The one or more operations of process 1000 may be implemented as software components that are executed and run on one or more processors.

At block 1002, a computing device (or one or more components thereof) may encode the audio data to generate first audio embeddings. For example, encoder 604 may encode audio data 602 to generate audio embeddings 606.

At block 1004, the computing device (or one or more components thereof) may adapt the first audio embeddings to generate second audio embeddings. For example, audio adapter 662 may adapt audio embeddings 606 to generate audio embeddings 664.

In some aspects, the computing device (or one or more components thereof) may adapt the first audio embeddings using an audio grounding adapter trained through a contrastive-learning process. For example, audio adapter 662 may adapt audio embeddings 606 to generate audio embeddings 664. Audio adapter 662 may be trained through a contrastive-learning process (e.g., as described with regard to FIG. 7).

In some aspects, the computing device (or one or more components thereof) may adapt the first audio embeddings using an audio grounding adapter trained based on a knowledge-distillation process using a contrastive-learning audio pretrained audio encoder. For example, audio adapter 662 may adapt audio embeddings 606 to generate audio embeddings 664. Audio adapter 662 may be trained through a knowledge-distillation process using a CLAP audio encoder 718 (e.g., as described with regard to FIG. 7.

At block 1006, the computing device (or one or more components thereof) may combine the first audio embeddings and the second audio embeddings to generate third audio embeddings. For example, cross attender 652 may combine audio embeddings 606 and audio embeddings 664 to generate audio embeddings 654.

In some aspects, the computing device (or one or more components thereof) may combine the first audio embeddings and the second audio embeddings using a cross-attention transformer. For example, cross attender 652 may combine audio embeddings 606 and audio embeddings 664 to generate audio embeddings 654.

At block 1008, the computing device (or one or more components thereof) may project the third audio embeddings to generate text projections. For example, projector 612 may project audio embeddings 656 (which is based on audio embeddings 654) to generate text projections 658.

In some aspects, the computing device (or one or more components thereof) may project the third audio embeddings using a projector trained to generate text projections based on audio embeddings. For example, projector 612 may project audio embeddings 656 to generate text projections 658.

At block 1010, the computing device (or one or more components thereof) may generate audio metadata based on the second audio embeddings. For example, converter 648 may generate audio metadata 650 based on classifications 646 (which is based on audio embeddings 664).

In some aspects, the audio metadata may be, or may include, a list of audio events and corresponding timestamps. For example, audio metadata 650 may be, or may include, a list of audio events and corresponding timestamps.

In some aspects, the computing device (or one or more components thereof) may generate the audio metadata based on at least one prior user input. For example, grounder 660 may use phrases 674 from prior instances of user inputs 618 to ground system 600. For instance, text encoder 666 may generate text embeddings 668 based on phrases 674. Audio-text matcher 670 may generate classifications 646 based on audio embeddings 664 and text embeddings 668. Converter 648 may generate audio metadata 650 based on classifications 646. Audio metadata 650 may be based, at least in part, on prior instances of user inputs 618. Thus, system 600 may use audio metadata 650 to store, implicitly, information based on prior instances of user inputs 618.

In some aspects, the computing device (or one or more components thereof) may process a prior user input using a text encoder to generate input embeddings, wherein the audio metadata is generated further based on the input embeddings. For instance, text encoder 666 may generate text embeddings 668 based on phrases 674. Audio-text matcher 670 may generate classifications 646 based on audio embeddings 664 and text embeddings 668. Converter 648 may generate audio metadata 650 based on classifications 646. Audio metadata 650 may be based, at least in part, on prior instances of user inputs 618. Thus, system 600 may use audio metadata 650 to store, implicitly, information based on prior instances of user inputs 618.

At block 1012, the computing device (or one or more components thereof) may process the text projections, the audio metadata, and a query using a machine-learning model to generate a response to the query. For example, LLM 616 may process text projections 658, audio metadata 650, and user inputs 618 to generate outputs 620.

In some aspects, the computing device (or one or more components thereof) may generate caption data based on the first audio embeddings, wherein the response is generated by further processing the caption data using the machine-learning model. For example, audio captioner 628 may generate audio captions 636 based on audio embeddings 606. LLM 616 may generate outputs 620 based on text projections 658, audio metadata 650, user inputs 618 and audio captions 636.

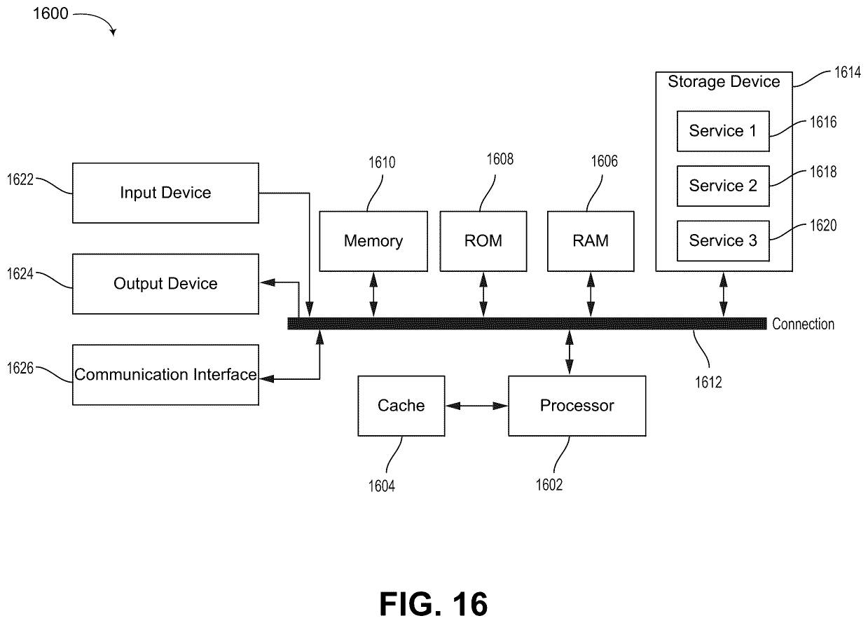

In some examples, as noted previously, the methods described herein (e.g., process 1000 of FIG. 10, and/or other methods described herein) can be performed, in whole or in part, by a computing device or apparatus. In one example, one or more of the methods can be performed by system 100 of FIG. 1, system 400 of FIG. 4, system 600 of FIG. 6, system 700 of FIG. 7, system 800 of FIG. 8, or by another system or device. In another example, one or more of the methods (e.g., process 1000, and/or other methods described herein) can be performed, in whole or in part, by the computing-device architecture 1600 shown in FIG. 16. For instance, a computing device with the computing-device architecture 1600 shown in FIG. 16 can include, or be included in, the components of the system 100, system 400, system 600, system 700, system 800, and can implement the operations of process 1000, and/or other process described herein. In some cases, the computing device or apparatus can include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device can include a display, a network interface configured to communicate and/or receive the data, any combination thereof, and/or other component(s). The network interface can be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

Process 1000, and/or other process described herein are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, process 1000, and/or other process described herein can be performed under the control of one or more computer systems configured with executable instructions and can be implemented as code (e.g., executable instructions, one or more computer programs, or one or more applications) executing collectively on one or more processors, by hardware, or combinations thereof. As noted above, the code can be stored on a computer-readable or machine-readable storage medium, for example, in the form of a computer program comprising a plurality of instructions executable by one or more processors. The computer-readable or machine-readable storage medium can be non-transitory.

As noted above, various aspects of the present disclosure can use machine-learning models or systems.

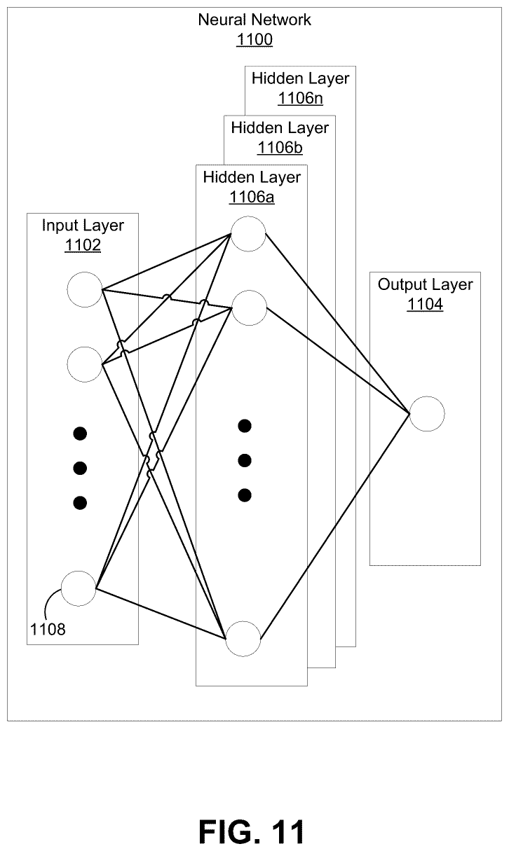

FIG. 11 is an illustrative example of a neural network 1100 (e.g., a deep-learning neural network) that can be used to implement machine-learning based feature segmentation, implicit-neural-representation generation, rendering, classification, object detection, image recognition (e.g., face recognition, object recognition, scene recognition, etc.), feature extraction, authentication, gaze detection, gaze prediction, and/or automation. For example, neural network 1100 may be an example of, or can implement, encoder 404, pooling 408, projection 412, encoder 440, classifier 444, encoder 430, and/or decoder 434 of FIG. 4, encoder 604, pooler 608, projector 612, decoder 634, audio adapter 662, text encoder 666, audio-text matcher 670, converter 648, and/or audio-text matcher 670 of FIG. 6, FIG. 7 FIG. 8, and FIG. 9.

An input layer 1102 includes input data. In one illustrative example, input layer 1102 can include data such as text data, numerical data, image data, audio data, video data, etc. Neural network 1100 includes multiple hidden layers, for example, hidden layers 1106a, 1106b, through 1106n. The hidden layers 1106a, 1106b, through hidden layer 1106n include “n” number of hidden layers, where “n” is an integer greater than or equal to one. The number of hidden layers can be made to include as many layers as needed for the given application. Neural network 1100 further includes an output layer 1104 that provides an output resulting from the processing performed by the hidden layers 1106a, 1106b, through 1106n. In one illustrative example, output layer 1104 can output data such as text data, numerical data, image data, audio data, video data, etc.

Neural network 1100 may be, or may include, a multi-layer neural network of interconnected nodes. Each node can represent a piece of information. Information associated with the nodes is shared among the different layers and each layer retains information as information is processed. In some cases, neural network 1100 can include a feed-forward network, in which case there are no feedback connections where outputs of the network are fed back into itself. In some cases, neural network 1100 can include a recurrent neural network, which can have loops that allow information to be carried across nodes while reading in input.

Information can be exchanged between nodes through node-to-node interconnections between the various layers. Nodes of input layer 1102 can activate a set of nodes in the first hidden layer 1106a. For example, as shown, each of the input nodes of input layer 1102 is connected to each of the nodes of the first hidden layer 1106a. The nodes of first hidden layer 1106a can transform the information of each input node by applying activation functions to the input node information. The information derived from the transformation can then be passed to and can activate the nodes of the next hidden layer 1106b, which can perform their own designated functions. Example functions include convolutional, up-sampling, data transformation, and/or any other suitable functions. The output of the hidden layer 1106b can then activate nodes of the next hidden layer, and so on. The output of the last hidden layer 1106n can activate one or more nodes of the output layer 1104, at which an output is provided. In some cases, while nodes (e.g., node 1108) in neural network 1100 are shown as having multiple output lines, a node has a single output and all lines shown as being output from a node represent the same output value.

In some cases, each node or interconnection between nodes can have a weight that is a set of parameters derived from the training of neural network 1100. Once neural network 1100 is trained, it can be referred to as a trained neural network, which can be used to perform one or more operations. For example, an interconnection between nodes can represent a piece of information learned about the interconnected nodes. The interconnection can have a tunable numeric weight that can be tuned (e.g., based on a training dataset), allowing neural network 1100 to be adaptive to inputs and able to learn as more and more data is processed.

Neural network 1100 may be pre-trained to process the features from the data in the input layer 1102 using the different hidden layers 1106a, 1106b, through 1106n in order to provide the output through the output layer 1104. In an example in which neural network 1100 is used to identify features in images, neural network 1100 can be trained using training data that includes both images and labels, as described above. For instance, training images can be input into the network, with each training image having a label indicating the features in the images (for the feature-segmentation machine-learning system) or a label indicating classes of an activity in each image. In one example using object classification for illustrative purposes, a training image can include an image of a number 2, in which case the label for the image can be [0 0 1 0 0 0 0 0 0 0].

In some cases, neural network 1100 can adjust the weights of the nodes using a training process called backpropagation. As noted above, a backpropagation process can include a forward pass, a loss function, a backward pass, and a weight update. The forward pass, loss function, backward pass, and parameter update are performed for one training iteration. The process can be repeated for a certain number of iterations for each set of training images until neural network 1100 is trained well enough so that the weights of the layers are accurately tuned.

For the example of identifying objects in images, the forward pass can include passing a training image through neural network 1100. The weights are initially randomized before neural network 1100 is trained. As an illustrative example, an image can include an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

As noted above, for a first training iteration for neural network 1100, the output will likely include values that do not give preference to any particular class due to the weights being randomly selected at initialization. For example, if the output is a vector with probabilities that the object includes different classes, the probability value for each of the different classes can be equal or at least very similar (e.g., for ten possible classes, each class can have a probability value of 0.1). With the initial weights, neural network 1100 is unable to determine low-level features and thus cannot make an accurate determination of what the classification of the object might be. A loss function can be used to analyze error in the output. Any suitable loss function definition can be used, such as a cross-entropy loss. Another example of a loss function includes the mean squared error (MSE), defined as Eₜₒₜₐₗ=Σ½ (target−output)². The loss can be set to be equal to the value of Eₜₒₜₐₗ.

The loss (or error) will be high for the first training images since the actual values will be much different than the predicted output. The goal of training is to minimize the amount of loss so that the predicted output is the same as the training label. Neural network 1100 can perform a backward pass by determining which inputs (weights) most contributed to the loss of the network and can adjust the weights so that the loss decreases and is eventually minimized. A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as w=wᵢ−η dL/dW, where w denotes a weight, wᵢ denotes the initial weight, and η denotes a learning rate. The learning rate can be set to any suitable value, with a high learning rate including larger weight updates and a lower value indicating smaller weight updates.

Neural network 1100 can include any suitable deep network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. Neural network 1100 can include any other deep network other than a CNN, such as an autoencoder, a deep belief nets (DBNs), a Recurrent Neural Networks (RNNs), among others.

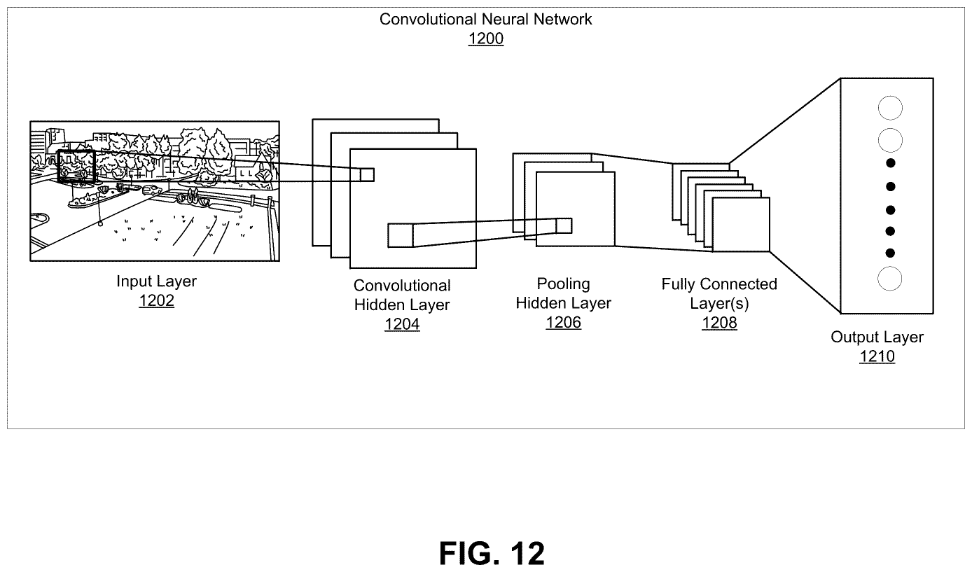

FIG. 12 is an illustrative example of a convolutional neural network (CNN) 1200. The input layer 1202 of the CNN 1200 includes data representing an image or frame. For example, the data can include an array of numbers representing the pixels of the image, with each number in the array including a value from 0 to 255 describing the pixel intensity at that position in the array. Using the previous example from above, the array can include a 28×28×3 array of numbers with 28 rows and 28 columns of pixels and 3 color components (e.g., red, green, and blue, or luma and two chroma components, or the like). The image can be passed through a convolutional hidden layer 1204, an optional non-linear activation layer, a pooling hidden layer 1206, and fully connected layer 1208 (which fully connected layer 1208 can be hidden) to get an output at the output layer 1210. While only one of each hidden layer is shown in FIG. 12, one of ordinary skill will appreciate that multiple convolutional hidden layers, non-linear layers, pooling hidden layers, and/or fully connected layers can be included in the CNN 1200. As previously described, the output can indicate a single class of an object or can include a probability of classes that best describe the object in the image.

The first layer of the CNN 1200 can be the convolutional hidden layer 1204. The convolutional hidden layer 1204 can analyze image data of the input layer 1202. Each node of the convolutional hidden layer 1204 is connected to a region of nodes (pixels) of the input image called a receptive field. The convolutional hidden layer 1204 can be considered as one or more filters (each filter corresponding to a different activation or feature map), with each convolutional iteration of a filter being a node or neuron of the convolutional hidden layer 1204. For example, the region of the input image that a filter covers at each convolutional iteration would be the receptive field for the filter. In one illustrative example, if the input image includes a 28×28 array, and each filter (and corresponding receptive field) is a 5×5 array, then there will be 24×24 nodes in the convolutional hidden layer 1204. Each connection between a node and a receptive field for that node learns a weight and, in some cases, an overall bias such that each node learns to analyze its particular local receptive field in the input image. Each node of the convolutional hidden layer 1204 will have the same weights and bias (called a shared weight and a shared bias). For example, the filter has an array of weights (numbers) and the same depth as the input. A filter will have a depth of 3 for an image frame example (according to three color components of the input image). An illustrative example size of the filter array is 5×5×3, corresponding to a size of the receptive field of a node.

The convolutional nature of the convolutional hidden layer 1204 is due to each node of the convolutional layer being applied to its corresponding receptive field. For example, a filter of the convolutional hidden layer 1204 can begin in the top-left corner of the input image array and can convolve around the input image. As noted above, each convolutional iteration of the filter can be considered a node or neuron of the convolutional hidden layer 1204. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 1204. For example, a filter can be moved by a step amount (referred to as a stride) to the next receptive field. The stride can be set to 1 or any other suitable amount. For example, if the stride is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 1204.

The mapping from the input layer to the convolutional hidden layer 1204 is referred to as an activation map (or feature map). The activation map includes a value for each node representing the filter results at each location of the input volume. The activation map can include an array that includes the various total sum values resulting from each iteration of the filter on the input volume. For example, the activation map will include a 24×24 array if a 5×5 filter is applied to each pixel (a stride of 1) of a 28×28 input image. The convolutional hidden layer 1204 can include several activation maps in order to identify multiple features in an image. The example shown in FIG. 12 includes three activation maps. Using three activation maps, the convolutional hidden layer 1204 can detect three different kinds of features, with each feature being detectable across the entire image.

In some examples, a non-linear hidden layer can be applied after the convolutional hidden layer 1204. The non-linear layer can be used to introduce non-linearity to a system that has been computing linear operations. One illustrative example of a non-linear layer is a rectified linear unit (ReLU) layer. A ReLU layer can apply the function f(x)=max(0, x) to all of the values in the input volume, which changes all the negative activations to 0. The ReLU can thus increase the non-linear properties of the CNN 1200 without affecting the receptive fields of the convolutional hidden layer 1204.

The pooling hidden layer 1206 can be applied after the convolutional hidden layer 1204 (and after the non-linear hidden layer when used). The pooling hidden layer 1206 is used to simplify the information in the output from the convolutional hidden layer 1204. For example, the pooling hidden layer 1206 can take each activation map output from the convolutional hidden layer 1204 and generates a condensed activation map (or feature map) using a pooling function. Max-pooling is one example of a function performed by a pooling hidden layer. Other forms of pooling functions be used by the pooling hidden layer 1206, such as average pooling, L2-norm pooling, or other suitable pooling functions. A pooling function (e.g., a max-pooling filter, an L2-norm filter, or other suitable pooling filter) is applied to each activation map included in the convolutional hidden layer 1204. In the example shown in FIG. 12, three pooling filters are used for the three activation maps in the convolutional hidden layer 1204.

In some examples, max-pooling can be used by applying a max-pooling filter (e.g., having a size of 2×2) with a stride (e.g., equal to a dimension of the filter, such as a stride of 2) to an activation map output from the convolutional hidden layer 1204. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 1204 having a dimension of 24×24 nodes, the output from the pooling hidden layer 1206 will be an array of 12×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling) and using the computed values as an output.

The pooling function (e.g., max-pooling, L2-norm pooling, or other pooling function) determines whether a given feature is found anywhere in a region of the image and discards the exact positional information. This can be done without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 1200.

The final layer of connections in the network is a fully-connected layer that connects every node from the pooling hidden layer 1206 to every one of the output nodes in the output layer 1210. Using the example above, the input layer includes 28×28 nodes encoding the pixel intensities of the input image, the convolutional hidden layer 1204 includes 3×24×24 hidden feature nodes based on application of a 5×5 local receptive field (for the filters) to three activation maps, and the pooling hidden layer 1206 includes a layer of 3×12×12 hidden feature nodes based on application of max-pooling filter to 2×2 regions across each of the three feature maps. Extending this example, the output layer 1210 can include ten output nodes. In such an example, every node of the 3×12×12 pooling hidden layer 1206 is connected to every node of the output layer 1210.

The fully connected layer 1208 can obtain the output of the previous pooling hidden layer 1206 (which should represent the activation maps of high-level features) and determines the features that most correlate to a particular class. For example, the fully connected layer 1208 can determine the high-level features that most strongly correlate to a particular class and can include weights (nodes) for the high-level features. A product can be computed between the weights of the fully connected layer 1208 and the pooling hidden layer 1206 to obtain probabilities for the different classes. For example, if the CNN 1200 is being used to predict that an object in an image is a person, high values will be present in the activation maps that represent high-level features of people (e.g., two legs are present, a face is present at the top of the object, two eyes are present at the top left and top right of the face, a nose is present in the middle of the face, a mouth is present at the bottom of the face, and/or other features common for a person).

In some examples, the output from the output layer 1210 can include an M-dimensional vector (in the prior example, M=10). M indicates the number of classes that the CNN 1200 has to choose from when classifying the object in the image. Other example outputs can also be provided. Each number in the M-dimensional vector can represent the probability the object is of a certain class. In one illustrative example, if a 10-dimensional output vector represents ten different classes of objects is [0 0 0.05 0.8 0 0.15 0 0 0 0], the vector indicates that there is a 5% probability that the image is the third class of object (e.g., a dog), an 80% probability that the image is the fourth class of object (e.g., a human), and a 15% probability that the image is the sixth class of object (e.g., a kangaroo). The probability for a class can be considered a confidence level that the object is part of that class.

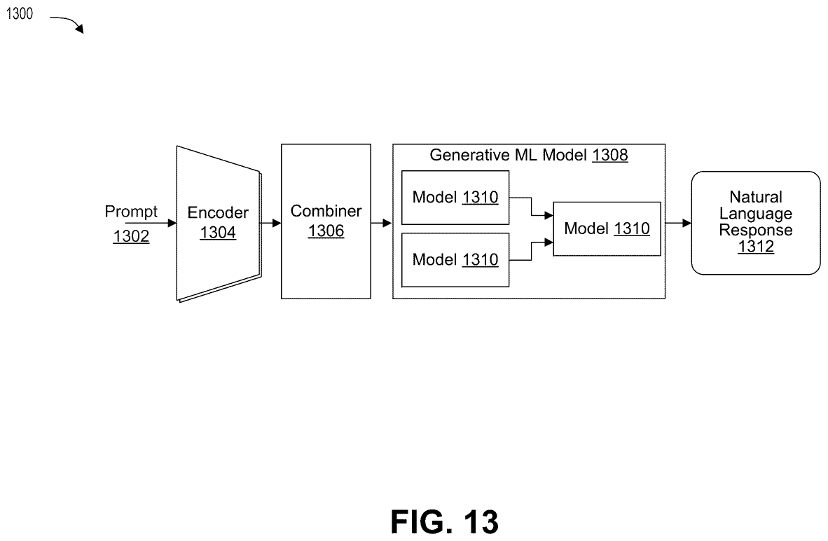

FIG. 13 is a block diagram illustrating a multimodal generative ML system 1300 for generating natural language responses based on natural language input from a prompt 1302 and any additional information. A multimodal machine learning system is a machine learning model that receives, processes, and outputs data in multiple forms. For example, the input prompt may include text, images, and audio. LLM 416 of FIG. 4, LLM 616 of FIG. 6 and FIG. 8 may be examples of multimodal generative ML system 1300.

For example, the multimodal generative ML system 1300 includes a plurality of encoders 1304 that are each configured to encode different modes of content (e.g., text, images, audio, etc.) into different tokens within a common embedding space. For example, a text input may be segmented based on different techniques (e.g., paragraph, sentence, etc.) and encoded by a text encoder (from the encoders 1304) into tokens. In another example, one or more images can be provided to an image encoder (from the encoders 1304) that extracts features associated with the image and generates tokens representing the visual features. In another example, audio can be provided to an audio encoder (from the encoders 1304) that extracts features associated with the image and generates tokens representing the audio features. In the case of audio, the audio encoder can identify features that can include formants that characterize resonant frequencies in speech, rhythmic features related to timing and tempo, and harmonic features that describe the relationship between fundamental frequencies and their harmonics.

The different tokens from the plurality of encoders are provided to combiner 1306. The combiner 1306 can combine the tokens based on the order in which they are presented. For example, the input into the encoder may be an array of primitive values. A primitive value is an immutable data type provided by a programming language and includes values that represent a single piece of data (e.g., number, string, Boolean, etc.) rather than a complex object or reference. A non-limiting example prompt may include a byte array (e.g., an unsigned 8-byte integer array or uint8array), and another string. The byte array may be audio, images, or other content that can be processed by the encoders 1304. In some aspects, the combiner 1306 is configured to concatenate the different tokens in order based on the array to preserve the semantic order of features and provide the tokens to the generative machine learning model 1308.

The generative machine learning model 1308 is configured to receive the tokens and generate a natural language response 1312 based on the tokens and the prompt 1302. Generative machine learning model 1308 may include one or more models 1310 (e.g., transformer neural network(s), diffusion model(s), fully connected layer(s), multilayer perceptrons (MLPs), any combination thereof, and/or other models). The one or more models 1310 of the generative machine learning model 1308 are configured to process the tokens and extract different types of features that are relevant to the prompt 1302. For example, the prompt 1302 can be a query for a particular type of information. The one or more models of the generative machine learning model 1308 can perform different tasks related to the query, such as writing code to perform a particular function, generating an image based on an input image with expressed modifications, generate an image without any input image, and so forth.

The generative machine learning model 1308 may include different components, such as a featurization engine to identify different types of features, an inference engine to identify inferences within the text (e.g., pronoun usage and corresponding disambiguation functions), data retrieval engines (e.g., to identify features related to a particular concept observed by the generative machine learning model 1308), and so forth. The generative machine learning model 1308 may also include different types of models and engines to synthesize a coherent contextual output, such as to synthesize the input content and information that is responsive to tasks embedded within the text. For example, the generative machine learning model 1308 may include a predictive output engine (not shown) that is configured to generate a sequence of words that is most likely contextually correct and to provide a coherent and contextually relevant answer. For instance, the predictive output generation engine can generate responses by sampling from the probability distribution of possible words and sequences based on patterns observed during training. The generative machine learning model 1308 may also include a predictive output generation engine to generate multiple responses that are potentially relevant and coherent with respect to the prompt 1302. The generative machine learning model 1308 may also include an output validation engine configured to evaluate the generated responses based on certain criteria. Non-limiting examples of criteria to evaluate generated responses include relevance to the prompt, coherence, fluency, and adherence to specific guidelines or rules. Based on the evaluation, the output validation engine may select and output the most appropriate response.

As noted above, the generative machine learning model 1308 may include various types of models (e.g., machine learning models), such as a transformer. A transformer is a neural network architecture that can be trained to perform one or more natural language processing (NLP) tasks, such as language translation, sentiment analysis, and text summarization. Conventional traditional recurrent neural networks (RNNs) process data in sequence. A transformer or transformer network can process input in parallel and can thus be faster and more efficient than sequential training and processing. In some aspects, a transformer can use a self-attention mechanism (e.g., one or more self-attention layers), which allows the transformer to identify the most relevant parts of the input text or content (e.g., audio or video). In some cases, a transformer can also use a cross-attention mechanism (e.g., one or more cross-attention layers) which uses other content or data to determine the most relevant parts of the input. For example, cross-attention mechanisms are useful in sequential content such as a stream of data, such as optical flow, and other computer vision techniques.

A transformer neural network can include a multi-layer encoder-decoder architecture. For instance, an encoder of the encoder-decoder architecture can receive text as input, convert the input text into a sequence of hidden representations, and capture the meaning of the text at different levels of abstraction. A decoder of the encoder-decoder architecture can then process the representations output from the decoder to generate an output sequence, such as a text translation or a summary. The encoder and decoder can be trained together using supervised learning, unsupervised learning, or a combination of supervised and unsupervised learning techniques, such as maximum likelihood estimation and self-supervised pretraining. Illustrative examples of transformer engines include a BERT model, a Text-to-Text Transfer Transformer (T5), biomedical BERT (BioBERT), scientific BERT (SciBERT), and the SPECTER model for document-level representation learning. In some aspects, multiple transformer engines may be used to generate different tokens.

In some aspects, the generative machine learning model 1308 may be executed using a neural engine (or multiple neural engines) for on-device execution, such as a neural processing unit (NPU), a neural signal processor (NSP), a digital signal processor (DSP), any combination thereof, and/or other neural engine. The neural engine can include a plurality of neural processing cores that are configured to parallelize operations associated with neural networks. A neural processing core can include arrays of multiply-accumulate (MAC) units and specialized instructions that are optimized for matrix operations, such as convolution and matrix multiplication. The neural processing core can receive input data and perform matrix transformations and nonlinear activation functions to break down and parallelize matrix operations. The neural processing core can perform tasks such as inference (e.g., runtime operation of a machine learning model) or training of deep learning models. The neural processing core can accelerate tasks by parallelization of larger computations that can be performed in parallel (e.g., matrix operations associated with neural networks). For instance, the neural engine may perform computer vision tasks such as object recognition. In some cases, the neural engine can be implemented based on various ML libraries such as PyTorch, which interfaces with the compute unified device architecture (CUDA) to parallelize operations.

In some aspects, the generative machine learning model 1308 may be a small generative model that has fewer parameters, fewer layers, fewer neurons, or a simpler architecture compared to larger models. A small generative model may not capture the full complexity of the underlying data distribution as effectively as larger models but can still be useful in scenarios where computational resources are limited or where a simpler model is sufficient for the task. Small generative models can also be easier to train and interpret, making them suitable for certain applications. For example, ChatGPT-3.5 has 175 billion parameters that results in a size of 1.4 Terabytes (TB) for a model implemented with double-precision floating point numbers. A smaller model may have a simpler architecture, use fewer parameters (e.g., 10 million), and use less precise numbers (e.g., single-precision floating point numbers) resulting in a size of 38 Megabytes (MB).

In addition, small models benefit from increased training based on local execution and data specific to a local device and a user of that local device. An additional benefit to small models is increased privacy because the information is not transmitted over the network and only relies on information requested by the user or usage at the local device.

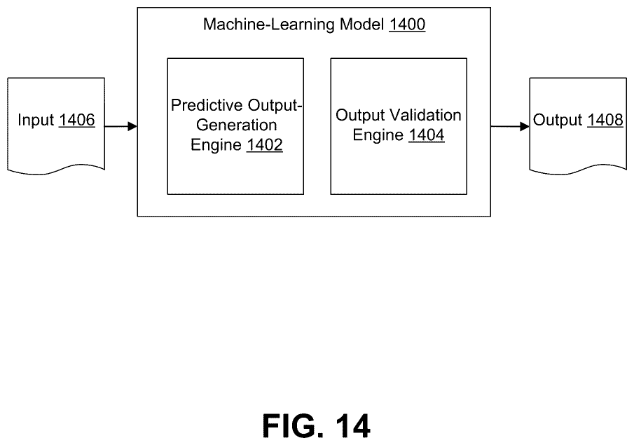

FIG. 14 includes an example machine-learning model 1400 that may be used in various aspects of the present disclosure. For example, LLM 416 of FIG. 4, LLM 616 of FIG. 6 and FIG. 8 may be examples of machine-learning model 1400.

Machine-learning model 1400 is an example of a generative response engine. Generative response engines are commonly referred to as Generative AI. Generative response engines can receive an input prompt (e.g., input 1406) and generate content (e.g., output 1408) based on the prompt. Generative Pre-trained Transformers (GPTs), diffusion models, and diffusion-transformer models are some non-limiting examples of generative response engines.

Machine-learning model 1400 includes a predictive output-generation engine 1402 and Output validation engine 1404. Predictive output-generation engine 1402 may analyze input 1406 and identify relevant patterns and associations based on data on which predictive output-generation engine 1402 was trained. Further, predictive output-generation engine 1402 may predict a sequence of words that are the most likely continuation of input 1406. By iteratively predicting next words, predictive output-generation engine 1402 may aim to provide a coherent and contextually relevant answer to input 1406. Predictive output-generation engine 1402 may generate responses by sampling from the probability distribution of possible words and sequences, guided by the patterns observed during the training of predictive output-generation engine 1402. In some aspects, predictive output-generation engine 1402 may generate multiple possible responses before outputting a final one. The multiple responses may be variations that predictive output-generation engine 1402 considers potentially relevant and coherent. Output validation engine 1404 may evaluate the multiple generated responses based on certain criteria. These criteria can include relevance to the prompt, coherence, fluency, and sometimes adherence to specific guidelines or rules, depending on the application. Based on this evaluation, output validation engine 1404 may select a most appropriate response. This selection is typically the one that scores highest on the set criteria, balancing factors like relevance, informativeness, and coherence.

Input 1406 and/or output 1408 may be, or may include, text, image data, video data, numerical data, etc. For example, machine-learning model 1400 may perform tasks such as, text summarization, text translation, text generation, responding to queries, image description, video description, image generation (e.g., based on text and/or image data), video generation (e.g., based on text and/or image data), image rendering (e.g., based on a 3D model and/or image data), object detection (e.g., based on image data and/or video data) etc. As such, machine-learning model 1400 may be referred to as a large language model (LLM), a vision-language model (VLM), a multilingual language model (MLLM) a large vision model (LVM), etc.

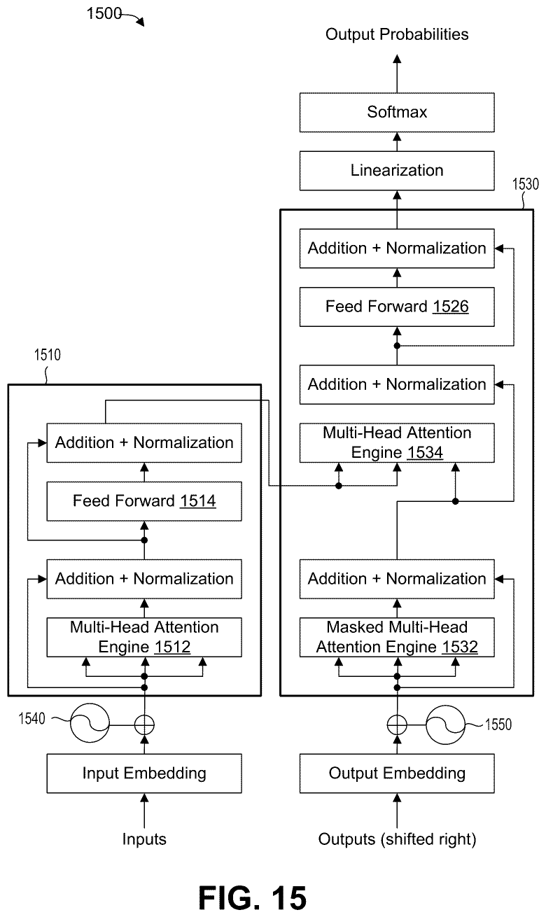

FIG. 15 is a block diagram of an example transformer 1500 in accordance with some aspects of the disclosure. For example, cross attender 652 may be an example of transformer 1500. Additionally, transformer 1500 may be included in multimodal generative ML system 1300 and/or machine-learning model 1400.

In a convolutional neural network (CNN) model, the number of operations required to relate signals from two arbitrary input or output positions grows in the distance between positions, which makes learning dependencies at different distant positions challenging for a CNN model. A transformer 1500 reduces the operations of learning dependencies by using an encoder 1510 and a decoder 1530 that implement an attention mechanism at different positions of a single sequence to compute a representation of that sequence. An attention function can be described as mapping a query and a set of key-value pairs to an output, where the query, keys, values, and output are all vectors. The output is computed as a weighted sum of the values, where the weight assigned to each value is computed by a compatibility function of the query with the corresponding key.

In one example of a transformer, the encoder 1510 is composed of a stack of six identical layers and each layer has two sub-layers. The first sub-layer is a multi-head self-attention engine 1512, and the second sub-layer is a fully-connected feed-forward network 1514. A residual connection (not shown) connects around each of the sub-layers followed by normalization.

In this example transformer 1500, the decoder 1530 is also composed of a stack of six 6 identical layers. The decoder also includes a masked multi-head self-attention engine 1532, a multi-head attention engine 1534 over the output of the encoder 1510, and a fully-connected feed-forward network 1526. Each layer includes a residual connection (not shown) around the layer, which is followed by layer normalization. The masked multi-head self-attention engine 1532 is masked to prevent positions from attending to subsequent positions and ensures that the predictions at position i can depend only on the known outputs at positions less than i (e.g., auto-regression).

In the transformer, the queries, keys, and values are linearly projected by a multi-head attention engine into learned linear projects, and then attention is performed in parallel on each of the learned linear projects, which are concatenated and then projected into final values.

The transformer also includes a positional encoder 1540 to encode positions because the model does not contain recurrence and convolution and relative or absolute position of the tokens is needed. In the transformer 1500, the positional encodings are added to the input embeddings at the bottom layer of the encoder 1510 and the decoder 1530. The positional encodings are summed with the embeddings because the positional encodings and embeddings have the same dimensions. A corresponding position decoder 1550 is configured to decode the positions of the embeddings for the decoder 1530.

In some aspects, the transformer 1500 uses self-attention mechanisms to selectively weigh the importance of different parts of an input sequence during processing and allows the model to attend to different parts of the input sequence while generating the output. The input sequence is first embedded into vectors and then passed through multiple layers of self-attention and feed-forward networks. The transformer 1500 can process input sequences of variable length, making it well-suited for natural language processing tasks where input lengths can vary greatly. Additionally, the self-attention mechanism allows the transformer 1500 to capture long-range dependencies between words in the input sequence, which is difficult for RNNs and CNNs. The transformer with self-attention has achieved results in several natural language processing tasks that are beyond the capabilities of other neural networks and has become a popular choice for language and text applications. For example, the various large language models, such as a generative pretrained transformer (e.g., ChatGPT, etc.) and other current models are types of transformer networks.

In some aspects, training of one or more of the machine-learning models described herein (e.g., such as encoder 404, pooling 408, projection 412, LLM 416, encoder 440, classifier 444, converter 448, encoder 430, and/or decoder 434 of FIG. 4, encoder 604, pooler 608, projector 612, LLM 616, cross attender 652, audio adapter 662, text encoder 666, audio-text matcher 670, converter 648, phrase extractor 672, and/or decoder 634 of FIG. 6, FIG. 7, and FIG. 8, and/or CLAP audio encoder 718 of FIG. 7, among various other machine learning networks described herein) can be performed using online training (e.g., in some case on-device training), offline training, and/or various combinations of online and offline training. In some cases, online may refer to time periods during which the input data (e.g., such as audio data 104 and user input 106 of FIG. 1, encode audio data 402 and user inputs 418 of FIG. 4, and/or audio data 602 and user inputs 618 of FIG. 6, etc.) is processed, for instance for performance of audio question answering the systems and techniques described herein. In some examples, offline may refer to idle time periods or time periods during which input data is not being processed. Additionally, offline may be based on one or more time conditions (e.g., after a particular amount of time has expired, such as a day, a week, a month, etc.) and/or may be based on various other conditions such as network and/or server availability, etc., among various others. In some aspects, offline training of a machine learning model (e.g., a neural network model) can be performed by a first device (e.g., a server device) to generate a pre-trained model, and a second device can receive the trained model from the second device. In some cases, the second device (e.g., a mobile device, an XR device, a vehicle or system/component of the vehicle, or other device) can perform online (or on-device) training of the pre-trained model to further adapt or tune the parameters of the model.

FIG. 16 illustrates an example computing-device architecture 1600 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. For example, the computing-device architecture 1600 may include, implement, or be included in any or all of system 100 of FIG. 1, system 400 of FIG. 4, system 600 of FIG. 6, system 700 of FIG. 7, system 800 of FIG. 8, and/or other devices, modules, or systems described herein. Additionally or alternatively, computing-device architecture 1600 may be configured to perform process 1000, and/or other process described herein.

The components of computing-device architecture 1600 are shown in electrical communication with each other using connection 1612, such as a bus. The example computing-device architecture 1600 includes a processing unit (CPU or processor) 1602 and computing device connection 1612 that couples various computing device components including computing device memory 1610, such as read only memory (ROM) 1608 and random-access memory (RAM) 1606, to processor 1602.

Computing-device architecture 1600 can include a cache of high-speed memory connected directly with, in close proximity to, or integrated as part of processor 1602. Computing-device architecture 1600 can copy data from memory 1610 and/or the storage device 1614 to cache 1604 for quick access by processor 1602. In this way, the cache can provide a performance boost that avoids processor 1602 delays while waiting for data. These and other modules can control or be configured to control processor 1602 to perform various actions. Other computing device memory 1610 may be available for use as well. Memory 1610 can include multiple different types of memory with different performance characteristics. Processor 1602 can include any general-purpose processor and a hardware or software service, such as service 1 1616, service 2 1618, and service 3 1620 stored in storage device 1614, configured to control processor 1602 as well as a special-purpose processor where software instructions are incorporated into the processor design. Processor 1602 may be a self-contained system, containing multiple cores or processors, a bus, memory controller, cache, etc. A multi-core processor may be symmetric or asymmetric.

To enable user interaction with the computing-device architecture 1600, input device 1622 can represent any number of input mechanisms, such as a microphone for speech, a touch-sensitive screen for gesture or graphical input, keyboard, mouse, motion input, speech and so forth. Output device 1624 can also be one or more of a number of output mechanisms known to those of skill in the art, such as a display, projector, television, speaker device, etc. In some instances, multimodal computing devices can enable a user to provide multiple types of input to communicate with computing-device architecture 1600. Communication interface 1626 can generally govern and manage the user input and computing device output. There is no restriction on operating on any particular hardware arrangement and therefore the basic features here may easily be substituted for improved hardware or firmware arrangements as they are developed.

Storage device 1614 is a non-volatile memory and can be a hard disk or other types of computer readable media which can store data that are accessible by a computer, such as magnetic cassettes, flash memory cards, solid state memory devices, digital versatile discs (DVDs), cartridges, random-access memories (RAMs) 1606, read only memory (ROM) 1608, and hybrids thereof. Storage device 1614 can include services 1616, 1618, and 1620 for controlling processor 1602. Other hardware or software modules are contemplated. Storage device 1614 can be connected to the computing device connection 1612. In one aspect, a hardware module that performs a particular function can include the software component stored in a computer-readable medium in connection with the necessary hardware components, such as processor 1602, connection 1612, output device 1624, and so forth, to carry out the function.

The term “substantially,” in reference to a given parameter, property, or condition, may refer to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, magnetic or optical disks, USB devices provided with non-volatile memory, networked storage devices, any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general-purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods described above. The computer-readable data storage medium may form part of a computer program product, which may include packaging materials. The computer-readable medium may include memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), flash memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general-purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, such as, a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:

Aspect 1. An apparatus for processing audio data, the apparatus comprising: one or more memories configured to store the audio data; and one or more processors coupled to the one or more memories and configured to: encode the audio data to generate first audio embeddings; adapt the first audio embeddings to generate second audio embeddings; combine the first audio embeddings and the second audio embeddings to generate third audio embeddings; project the third audio embeddings to generate text projections; generate audio metadata based on the second audio embeddings; and process the text projections, the audio metadata, and a query using a machine-learning model to generate a response to the query.

Aspect 2. The apparatus of aspect 1, wherein the one or more processors are configured to generate caption data based on the first audio embeddings, wherein the response is generated by further processing the caption data using the machine-learning model.

Aspect 3. The apparatus of any one of aspects 1 or 2, wherein the one or more processors are configured to adapt the first audio embeddings using an audio grounding adapter trained through a contrastive-learning process.

Aspect 4. The apparatus of any one of aspects 1 to 3, wherein the one or more processors are configured to adapt the first audio embeddings using an audio grounding adapter trained based on a knowledge-distillation process using a contrastive-learning audio pretrained audio encoder.

Aspect 5. The apparatus of any one of aspects 1 to 4, wherein the one or more processors are configured to combine the first audio embeddings and the second audio embeddings using a cross-attention transformer.

Aspect 6. The apparatus of any one of aspects 1 to 5, wherein the one or more processors are configured to project the third audio embeddings using a projector trained to generate text projections based on audio embeddings.

Aspect 7. The apparatus of any one of aspects 1 to 6, wherein the audio metadata comprises a list of audio events and corresponding timestamps.

Aspect 8. The apparatus of any one of aspects 1 to 7, wherein the one or more processors are configured to generate the audio metadata based on at least one prior user input.

Aspect 9. The apparatus of any one of aspects 1 to 8, wherein the one or more processors are configured to process a prior user input using a text encoder to generate input embeddings, wherein the audio metadata is generated further based on the input embeddings.

Aspect 10. A method for processing audio data, the method comprising: encoding audio data to generate first audio embeddings; adapting the first audio embeddings to generate second audio embeddings; combining the first audio embeddings and the second audio embeddings to generate third audio embeddings; projecting the third audio embeddings to generate text projections; generating audio metadata based on the second audio embeddings; and processing the text projections, the audio metadata, and a query using a machine-learning model to generate a response to the query.

Aspect 11. The method of aspect 10, further comprising generating caption data based on the first audio embeddings, wherein the response is generated by further processing the caption data using the machine-learning model.

Aspect 12. The method of any one of aspects 10 or 11, wherein the first audio embeddings are adapted using an audio grounding adapter trained through a contrastive-learning process.

Aspect 13. The method of any one of aspects 10 to 12, wherein the first audio embeddings are adapted using an audio grounding adapter trained based on a knowledge-distillation process using a contrastive-learning audio pretrained audio encoder.

Aspect 14. The method of any one of aspects 10 to 13, wherein the first audio embeddings and the second audio embeddings are combined using a cross-attention transformer.

Aspect 15. The method of any one of aspects 10 to 14, wherein the third audio embeddings are projected using a projector trained to generate text projections based on audio embeddings.

Aspect 16. The method of any one of aspects 10 to 15, wherein the audio metadata comprises a list of audio events and corresponding timestamps.

Aspect 17. The method of any one of aspects 10 to 16, wherein the audio metadata is generated based on at least one prior user input.

Aspect 18. The method of any one of aspects 10 to 17, further comprising processing a prior user input using a text encoder to generate input embeddings, wherein the audio metadata is generated further based on the input embeddings.

Aspect 19. A non-transitory computer-readable medium having stored thereon instructions that, when executed by one or more processors, cause the one or more processors to: encode the audio data to generate first audio embeddings; adapt the first audio embeddings to generate second audio embeddings; combine the first audio embeddings and the second audio embeddings to generate third audio embeddings; project the third audio embeddings to generate text projections; generate audio metadata based on the second audio embeddings; and process the text projections, the audio metadata, and a query using a machine-learning model to generate a response to the query.

Aspect 20. The non-transitory computer-readable medium of aspect 19, wherein the instructions, when executed by the one or more processors, cause the one or more processors to generate caption data based on the first audio embeddings, wherein the response is generated by further processing the caption data using the machine-learning model.

Aspect 21. A non-transitory computer-readable storage medium having stored thereon instructions that, when executed by at least one processor, cause the at least one processor to perform operations according to any of aspects 10 to 18.

Aspect 22. An apparatus for processing audio data, the apparatus comprising one or more means for perform operations according to any of aspects 10 to 18.

Aspect 23. The apparatus of any one of aspects 1 to 9, further comprising a microphone to record audio, wherein the one or more processors is configured to convert the recorded audio into the query.

Aspect 24. The apparatus of any one of aspects 1 to 9 or 23, wherein the one or more processors are configured to convert the response into an audio signal, the apparatus further comprising a speaker to play the audio signal.

What is claimed is:

1. An apparatus for processing audio data, the apparatus comprising:
one or more memories configured to store the audio data; and
one or more processors coupled to the one or more memories and configured to:
encode the audio data to generate first audio embeddings;
adapt the first audio embeddings to generate second audio embeddings;
combine the first audio embeddings and the second audio embeddings to generate third audio embeddings;
project the third audio embeddings to generate text projections;
generate audio metadata based on the second audio embeddings; and
process the text projections, the audio metadata, and a query using a machine-learning model to generate a response to the query.

2. The apparatus of claim 1, wherein the one or more processors are configured to generate caption data based on the first audio embeddings, wherein the response is generated by further processing the caption data using the machine-learning model.

3. The apparatus of claim 1, wherein the one or more processors are configured to adapt the first audio embeddings using an audio grounding adapter trained through a contrastive-learning process.

4. The apparatus of claim 1, wherein the one or more processors are configured to adapt the first audio embeddings using an audio grounding adapter trained based on a knowledge-distillation process using a contrastive-learning audio pretrained audio encoder.

5. The apparatus of claim 1, wherein the one or more processors are configured to combine the first audio embeddings and the second audio embeddings using a cross-attention transformer.

6. The apparatus of claim 1, wherein the one or more processors are configured to project the third audio embeddings using a projector trained to generate text projections based on audio embeddings.

7. The apparatus of claim 1, wherein the audio metadata comprises a list of audio events and corresponding timestamps.

8. The apparatus of claim 1, wherein the one or more processors are configured to generate the audio metadata based on at least one prior user input.

9. The apparatus of claim 1, wherein the one or more processors are configured to process a prior user input using a text encoder to generate input embeddings, wherein the audio metadata is generated further based on the input embeddings.

10. The apparatus of claim 1, further comprising a microphone to record audio, wherein the one or more processors is configured to convert the recorded audio into the query.

11. The apparatus of claim 1, wherein the one or more processors are configured to convert the response into an audio signal, the apparatus further comprising a speaker to play the audio signal.

12. A method for processing audio data, the method comprising:
encoding audio data to generate first audio embeddings;
adapting the first audio embeddings to generate second audio embeddings;
combining the first audio embeddings and the second audio embeddings to generate third audio embeddings;
projecting the third audio embeddings to generate text projections;
generating audio metadata based on the second audio embeddings; and
processing the text projections, the audio metadata, and a query using a machine-learning model to generate a response to the query.

13. The method of claim 12, further comprising generating caption data based on the first audio embeddings, wherein the response is generated by further processing the caption data using the machine-learning model.

14. The method of claim 12, wherein the first audio embeddings are adapted using an audio grounding adapter trained through a contrastive-learning process.

15. The method of claim 12, wherein the first audio embeddings are adapted using an audio grounding adapter trained based on a knowledge-distillation process using a contrastive-learning audio pretrained audio encoder.

16. The method of claim 12, wherein the first audio embeddings and the second audio embeddings are combined using a cross-attention transformer.

17. The method of claim 12, wherein the third audio embeddings are projected using a projector trained to generate text projections based on audio embeddings.

18. The method of claim 12, wherein the audio metadata comprises a list of audio events and corresponding timestamps.

19. The method of claim 12, wherein the audio metadata is generated based on at least one prior user input.

20. A non-transitory computer-readable medium having stored thereon instructions that, when executed by one or more processors, cause the one or more processors to:
encode audio data to generate first audio embeddings;
adapt the first audio embeddings to generate second audio embeddings;
combine the first audio embeddings and the second audio embeddings to generate third audio embeddings;
project the third audio embeddings to generate text projections;
generate audio metadata based on the second audio embeddings; and
process the text projections, the audio metadata, and a query using a machine-learning model to generate a response to the query.
